(19) United States
(12) Patent Application Publication
(10) Pub. No.: US 2005/0126398 A1
(43) Pub. Date: Jun. 16, 2005

(54) Device for infusions of coffee

(76) Inventor: Jose Luis Ascaso Lopez, Llobregat (ES)

Correspondence Address: SUGHRUE MION, PLLC, 2100 PENNSYLVANIA AVENUE, N.W., SUITE 800, WASHINGTON, DC, 20037, US

(21) Appl. No.: 10/508,862

(22) PCT Filed: Oct. 2, 2003
(86) PCT No.: PCT/EP02/13161

(30) Foreign Application Priority Data
Mar. 25, 2002 (ES) U 200200731

(51) Int. Cl. A23F 3/00

(52) U.S. Cl. 99/279

(57) ABSTRACT

The device comprises a heat exchanger (1), an infusion mechanism (2) and a dosage carrying mechanism (3), all being coupled vertically and integrally in continuation from the other and defining a longitudinal axis (Y-Y). The dosage carrying mechanism (3) comprises a longitudinal movement mechanism provided with an arm drive (31), adapted in such a way that the rotation of the drive arm (31) in one direction causes the upward vertical movement of the mechanism (2) placing the dosage in the infusion mechanism (2) outlet chamber (26), and the rotation of the drive arm (31) in the opposite direction causes the downward movement of the mechanism (2) allowing the extraction of the dosage used.

### TECHNICAL SECTOR OF THE INVENTION

The object of the invention is a device for infusions of coffee, of the type habitually used in catering and in the home for the infusion of dosages of coffee.

### BACKGROUND TO THE INVENTION

Multiple embodiments are known of devices for infusions of coffee in pre-measured dosages. Essentially, the known embodiments of such devices comprise a water tank, a heat exchanger, for example, an electrical one, an infusion mechanism and a dosage carrying mechanism. In general, said tank, heat exchanger and infusion mechanism constitute a functional unit, independent of the dosage carrying mechanism, which is coupled and uncoupled from said functional unit for the loading and unloading of the coffee dosage, that is, the dosage carrying mechanism constitutes a unit, which is independent of the device that needs to be coupled and uncoupled by the user in each infusion operation.

The inventor does not know of devices for coffee infusions in which the heat exchanger, the infusion mechanism and the dosage carrying mechanism are integrated into a single functional unit, wherein the dosage carrying mechanism is accessible by the user for the preparation of the infusion.

### EXPLANATION OF THE INVENTION

The device for coffee infusions object of the invention is characterised in that it comprises a heat exchanger, an infusion mechanism and a coffee dosage carrying mechanism, one being coupled vertically and integrally in continuation from the other and defining a longitudinal axis, in which the heat exchanger is provided with water inlet means and water outlet means at a higher temperature; the infusion mechanism comprises a water inlet chamber coming from the heat exchanger and an outlet chamber adapted for receiving the dosage; the dosage carrying mechanism comprises a longitudinal movement mechanism provided with a drive arm, capable of rotating in both directions around said longitudinal axis, all of which is adapted in such a way that, once the dosage has been placed in the dosage carrying mechanism, the rotation of the drive arm in one direction brings about the upward vertical movement of the dosage, placing it in the infusion mechanism outlet chamber, whereas the rotation of the drive arm in the opposite direction to the previous one brings about downward movement of the dosage used, allowing its extraction.

According to another feature of the device of the invention, the infusion mechanism comprises an intetmediate body fastened to the heat exchanger and provided with a stepped centred through orifice, configuring three successuve portions in progressively decreasing section from top to bottom, in which the upper portion is adapted for housing a tightening discoidal element, provided with a centred through orifice for the water coming from the heat exchanger, and a membrane, the water inlet chamber being defined between the discoidal element and the membrane, whereas the intermediate portion and the lower portion are adapted for housing a piston provided with a centred through orifice, in which a retention valve, integral to the membrane is housed and, at its lower end, to a cavity which configures the outlet chamber.

It is also a feature of the device of the invention that the dosage carrying mechanism comprises a tubular body that houses a thrust body and a dosage carrying body, all of them being arranged co-axially and mutually coupled, in which the tubular body, at its upper end, is provided with means for its fastening to the intermediate body of the infusion mechanism, and laterally, has large apertures adapted for allowing the dosage to pass therethrough, before and after being used, and, at its lower end, has means for the coupling of the thrust body and of the dosage carrying body; the thrust body is fastened to the drive arm and has a centred through orifice; and the dosage carrying body has a cavity for receiving a dosage and has outlet means of the infusion which go through the centred through orifice of the thrust body.

Another feature of the device of the invention consists of the fact that the longitudinal movement mechanism comprises, both in the thrust body and laterally, two radial thrust protuberances adapted for being housed in respective helicoidal thrust grooves which the dosage carrying body is provided with, the dosage carrying body also being provided with two radial guide protuberances adapted for being housed in respective guide grooves which the tubular body is provided with, all of it being adapted in such a way that the rotation of the drive arm causes the thrust body to turn and the sliding of the radial thrust protuberances through the helicoidal thrust grooves of the dosage carrying body, which is thrust vertically, guided by the radial guide protuberances through the guide grooves in the direction corresponding to the rotation of the drive arm.

### BRIEF DESCRIPTION OF THE DRAWINGS

A form of embodiment of the device for the infusion of coffee object of the invention is illustrated in the attached drawings by way of non-limiting example:

FIG. 1 is a longitudinal section view of the device for the infusion of coffee object of the invention.

FIG. 2 is a perspective view of the components of the device of FIG. 1.

### DETAILED DESCRIPTION OF THE DRAWINGS

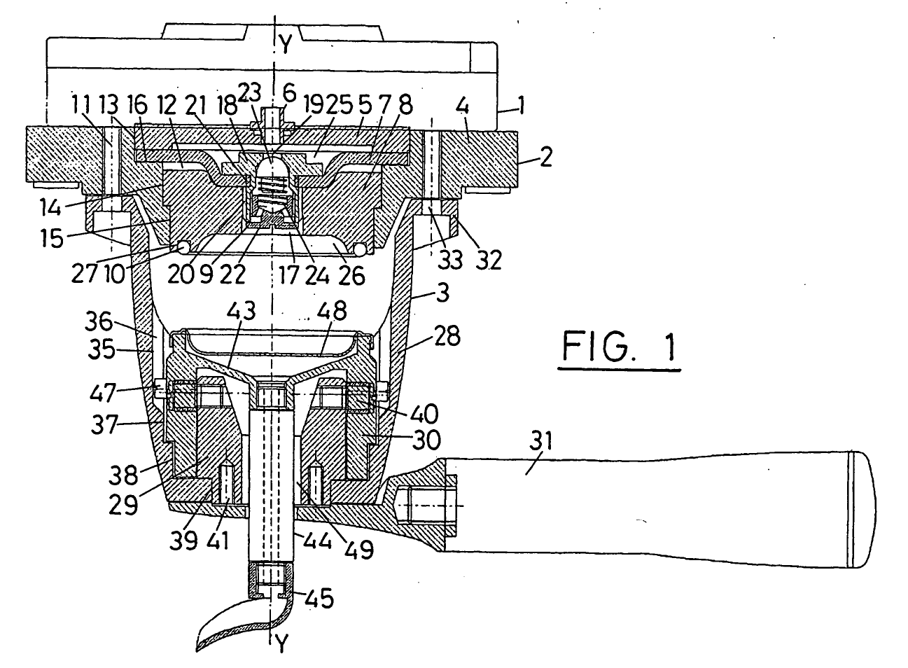

In FIG. 1, the device for the infusion of coffee object of the invention is represented, wherein it can be appreciated that the device comprises a heat exchanger 1, an infusion mechanism 2 and a dosage carrying mechanism 3, coupled vertically and integrally in continuation from the other and defining a longitudinal axis Y-Y. For the purposes of simplifying the description, the representation of the electrical and water supply means to the heat exchanger 1 has been obviated, as well as any other known components incorporable to the device, for example, such as a support for the device.

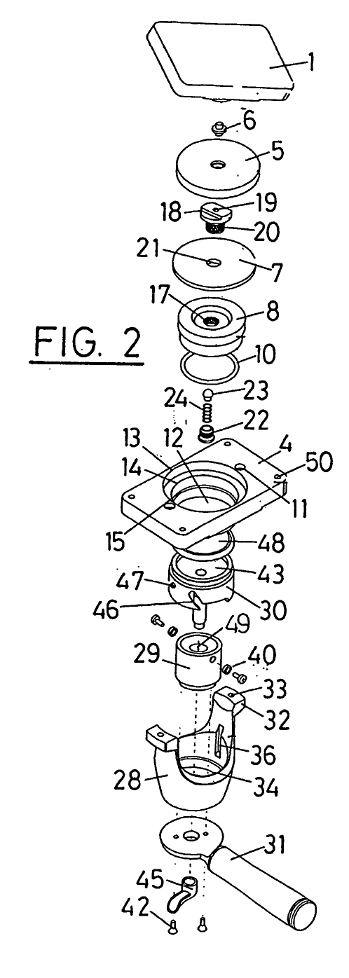

In the description which follows of the device of the invention, both FIGS. 1 and 2 are referred to.

The infusion mechanism 2 comprises an intermediate body 4, a tightening discoidal element 5, a through sleeve 6, a membrane 7, a piston 8, a retention valve 9 and a watertight seal 10. The intermediate body 4 is provided with through orifices 50 for fastening to the heat exchanger 1 by means of screws, are represented, and with through orifices 11 for the coupling of the dosage carrying mechanism 3, and with a centred through orifice 12 configuring three successive portions in progressively decreasing section from top to bottom, with an upper portion 13, an intermediate portion 14 and a lower portion 15 connected by means of steps: the upper portion 13 is adapted for housing the discoidal element 5, which is fastened to the heat exchanger 1 by means of the through sleeve 6, and the membrane 7, which remains fastened at its perimeter by compression between the discoidal element 5 and the step 16 that configures the connection of the upper portion 13 with the intermediate portion 14. The intermediate portion 14 and the lower portion 15 are adapted for housing the piston 8 in such a way that the latter is capable of moving vertically in both directions, the piston 8 being provided with a centred through orifice 17. The retention valve 9 comprises a main hollow body 18, provided with an entrance orifice 19 and a thread 20 for its coupling by threading to the piston 8 through a centred orifice 21, which the membrane 7 is provided with, in such a way that the latter remains fastened to the piston 8. Furthermore, the retention valve 9 comprises an outlet body 22, a closing body 23 and a closing spring 24, which works permanently by compression. With the described arrangement of the infusion mechanism 2 a water inlet chamber 25 remains configured between the discoidal element 5 and the membrane 7 and, at the lower end of the piston 8, a cavity comprising a water outlet chamber 26, the watertight seal 10 being arranged in a groove 27, perimetral to the outlet chamber 26.

The dosage carrying mechanism 3 comprises a tubular body 28, a thrust body 29 and a dosage carrying body 30, which are co-axially arranged and mutually coupled. At its upper end the tubular body 28 is provided with radial protuberances 32, fitted with respective through orifices 33, adapted for their fastening to the intermediate body 4 by means of screws, not represented, and laterally with two spacious facing apertures 34, adapted for the passage of a dosage of coffee, not represented, and at its lower end, inside, with four cylindrical portions in progressively decreasing section from top to bottom and connected by steps, in which the upper portion 35, the first intermediate portion 37, and the second intermediate portion 38, receive the dosage carrying body 30, and the lower portion 39 receives the thrust body 29. The thrust body 29 has an essentially cylindrical shape and is provided with a centred orifice 49, and at its lower end with two threaded orifices 41 for fastening the drive arm 31 by means of two screws 42. The dosage carrying body 30 has an essentially tubular shape, closed at its upper end and configuring a hollow inverted truncated cone portion 43 as if it were a funnel, adapted for receiving a removable dosage 48, which extends into a tubular conduit 44 that traverses the thrust body 29 and ends in a pump 45 for the pouring of the coffee infusion.

The arrangement of the piston 8 makes possible that, on receiving the dosage carrying body 30 driven by the thrust mechanism 29, it is capable of tilting slightly in order to ensure the complete water-tightness of the coupling. The tilting movement is possible thanks to the pressure the piston exerts on the membrane 7, arranged above the piston and generally made of flexible material, as a consequence of the pressure the thrust body exerts on the piston itself.

The dosage carrying mechanism 3 is provided with a movement mechanism of the dosage carrying body 30 which comprises the following elements. In the thrust body 29 and laterally two radial thrust protuberances 40 arranged diametrically with respect to the other: in the dosage carrying body 30 and laterally two helicoidal thrust grooves 46, adapted for receiving corresponding radial thrust protuberances 40 from the thrust body 29, and two radial guide protuberances 47 arranged diametrically to each other; and in the tubular body 28, and in the upper portion 35, two guide grooves 36 adapted for receiving corresponding radial guide protuberances 47 from the dosage carrying body 30.

The operation of the device of the invention is described below. The rotation of the drive arm 31 in one direction causes the corresponding rotation of the thrust body 29, whose radial thrust protuberances 40 drive the dosage carrying body 30 upwards by means of the helicoidal thrust grooves 46 that it is provided with, while the radial guide protuberances 47 of the dosage carrying body 30 slide vertically through the guide grooves 36 of the tubular body 28, preventing the rotation of the dosage carrying body 30, said vertical movement continuing until the dosage carrying body 30 reaches a position in which the dosage, arranged in the removable dosage 48 through the apertures 34 and not represented, remains arranged in the outlet chamber 26 of the infusion mechanism 2, immediately proceeding to the coffee infusion by means of the high temperature water coming from the heat exchanger 1 and through the inlet chamber 25 and the retention valve 9. Once the coffee infusion has been made, the rotation of the drive arm 31 in the opposite direction to the previous one, causes the downward vertical movement of the dosage carrying body 30, to the position represented in FIG. 1, from where the coffee dosage used is withdrawn through the apertures 34 of the tubular body 28, the device of the invention being arranged for a new infusion.

1. A device for the infusion of coffee, which comprises a heat exchanger (1), provided with water inlet means and water outlet means at a higher temperature; an infusion mechanism (2), that comprises a water inlet chamber (25) coming from the heat exchanger (1) and an outlet chamber (26) adapted for receiving the dosage; and a coffee dosage carrying mechanism (3), the device being characterised in that the heat exchanger (1), the infusion mechanism (2) and the dosage carrying mechanism (3) are coupled vertically and integrally in continuation from the other and defining a longitudinal axis (Y-Y), and in that the dosage carrying mechanism (3) comprises a longitudinal movement mechanism provided with a drive arm (31), capable of rotating in both directions around said longitudinal axis (Y-Y), all of which is adapted in such a way that, once the dosage has been placed in a dosage carrying body (30) of the dosage carrying mechanism (3), the rotation of the drive arm (31) in one direction brings about the upward vertical movement of the dosage, placing it in the infusion mechanism (2) outlet chamber (26), whereas the rotation of the drive arm (31) in the opposite direction to the previous one brings about the downward movement of the dosage used, allowing its extraction.

2. A device according to claim 1, which is characterised in that the infusion mechanism (2) comprises an intermediate body (4) fastened to the heat exchanger (1) and provided with a stepped centred through orifice (12), configuring three successive portions in progressively decreasing section from top to bottom, in which the upper portion (13) is adapted for housing a tightening discoidal element (5), provided with a centred through orifice for the water coming from the heat exchanger (1), and a membrane (7), the water inlet chamber (25) being defined between the discoidal element (5) and the membrane (7), whereas the intermediate portion (14) and the lower portion (15) are adapted for housing a piston (8) provided with a centred through orifice (17), in which a retention valve (9), integral to the membrane (7) is housed and, at its lower end, to a cavity which configures the outlet chamber (26).

3. A device according to claim 1, which is characterised in that the dosage carrying mechanism (3) comprises a tubular body (28) that houses a thrust body (29) and a dosage carrying body (30), all of them being arranged co-axially and mutually coupled, in which the tubular body (28) is provided at its upper end with means (32, 33) for its fastening to the intermediate body (4) of the infusion mechanism (2), and laterally, has spacious apertures (34) adapted for allowing the dosage to pass therethrough, before and after being used, and, at its lower end, has means (35, 37, 38, 39) for the coupling of the thrust body (29) and of the dosage carrying body (30); the thrust body (29) is fastened to the drive arm (31) and has a centred through orifice (49); and the dosage carrying body (30) has a cavity (43) for receiving a dosage and has outlet means (44, 45) of the infusion which go through the centred through orifice (49) of the thrust body (29).

4. A device according to claim 1, which is characterised in that the longitudinal movement mechanism comprises, both in the thrust body (29) and laterally, two radial thrust protuberances (40) adapted for being housed in respective thrust helicoidal grooves (46) which the dosage carrying body (30) is provided with, the dosage carrying body (30) also being provided with two radial guide protuberances (47) adapted for being housed in respective guide grooves (36) which the tubular body (28) is provided with, all of it being adapted in such a way that the rotation of the drive arm (31) causes the thrust body (29) to turn and the sliding of the radial thrust protuberances (40) through the thrust helicoidal grooves (46) of the dosage carrying body (30), which is thrust vertically, guided by the radial guide protuberances (47) through the guide grooves (36) in the direction corresponding to the rotation of the drive arm (31).

5. A device according to claim 2, which is characterised in that the dosage carrying mechanism (3) comprises a tubular body (28) that houses a thrust body (29) and a dosage carrying body (30), all of them being arranged co-axially and mutually coupled, in which the tubular body (28) is provided at its upper end with means (32, 33) for its fastening to the intermediate body (4) of the infusion mechanism (2), and laterally, has spacious apertures (34) adapted for allowing the dosage to pass therethrough, before and after being used, and, at its lower end, has means (35, 37, 38, 39) for the coupling of the thrust body (29) and of the dosage carrying body (30); the thrust body (29) is fastened to the drive arm (31) and has a centred through orifice (49); and the dosage carrying body (30) has a cavity (43) for receiving a dosage and has outlet means (44, 45) of the infusion which go through the centred through orifice (49) of the thrust body (29).

6. A device according to claim 2, which is characterised in that the longitudinal movement mechanism comprises, both in the thrust body (29) and laterally, two radial thrust protuberances (40) adapted for being housed in respective thrust helicoidal grooves (46) which the dosage carrying body (30) is provided with, the dosage carrying body (30) also being provided with two radial guide protuberances (47) adapted for being housed in respective guide grooves (36) which the tubular body (28) is provided with, all of it being adapted in such a way that the rotation of the drive arm (31) causes the thrust body (29) to turn and the sliding of the radial thrust protuberances (40) through the thrust helicoidal grooves (46) of the dosage carrying body (30), which is thrust vertically, guided by the radial guide protuberances (47) through the guide grooves (36) in the direction corresponding to the rotation of the drive arm (31)..

7. A device according to claim 3, which is characterised in that the longitudinal movement mechanism comprises, both in the thrust body (29) and laterally, two radial thrust protuberances (40) adapted for being housed in respective thrust helicoidal grooves (46) which the dosage carrying body (30) is provided with, the dosage carrying body (30) also being provided with two radial guide protuberances (47) adapted for being housed in respective guide grooves (36) which the tubular body (28) is provided with, all of it being adapted in such a way that the rotation of the drive arm (31) causes the thrust body (29) to turn and the sliding of the radial thrust protuberances (40) through the thrust helicoidal grooves (46) of the dosage carrying body (30), which is thrust vertically, guided by the radial guide protuberances (47) through the guide grooves (36) in the direction corresponding to the rotation of the drive arm (31).
